(19) United States
(12) Patent Application Publication
(10) Pub. No.: US 2002/0043861 A1
(43) Pub. Date: Apr. 18, 2002

(54) Supplementary elbow pad for arm rests

(76) Inventor: Michael Everett Meadows, Schoharie, NY (US)

Correspondence Address: Michael E. Meadows, 282-1 Barton Hill Road, Schoharie, NY, 12157, US

(21) Appl. No.: 09/909,345

(22) Filed: Jul. 19, 2001

Related U.S. Application Data
(60) Provisional application No. 60/221,133, filed on Jul. 27, 2000.

(51) Int. Cl. A47C 7/54; B60N 3/02

(52) U.S. Cl. 297/411.21

(57) ABSTRACT

A supplemenetal stick-on elbow pad for vehicle or chair armrests for added comfort. The low profile resilient pad protects only on the high pressure and friction elbow contact area, permitting a small size that avoids interference with most door handles and controls, along with a flexibility that lets it twist, bend, and contour to the existing armrest shape for secure bonding and a lower probability of being knocked loose.

### CROSS-REFERENCE TO RELATED APPLICATIONS

Application No. 60/221,133

Filing Date: Jul. 27, 2000

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The fields of the invention are mainly automotive (or vehicle) seat armrest and chair armrest accessories. The patent classes most applicable to this invention are class 248 “Supports”, 296 “Land Vehicles: Bodies and Tops” and 297 “Chairs and Seats”.

The purpose of the invention is to improve or enhance comfort for the elbow, which is often overlooked in various types of seating with hard armrests. The prior art that most directly addresses this problem for vehicles is found in two prior U.S. Pat. No. 5,332,288 (Coates, 1993) and U.S. Pat. No. 5,692,711 (Tucker, 1996). However, Coates requires a pre-exisiting shelf type armrest having an opening through or around it for the pad attachment straps to fasten through. Tucker requires a shelf type armrest with a perpendicular door panel next to it for Velcro side fasteners to hold it in place, while the armrest supports it. Both are relatively long, so that the Coates patent obstructs the door handle, while the Tucker patent addresses this with relatively tall padding that leaves space for a bottom side cutout for access to the door handle. Other references are: U.S. Pat. Nos. 2,789,862/ 3,123,403/ 4,331,360/ 4,810,026/ 4,858,995/ 5,009,468 and 5,979,987.

### BRIEF SUMMARY OF THE INVENTION

The new invention focuses only on the pressure point of the elbow area itself, as the real source of discomfort. The prior designs for vehicles provided coverage for the entire forearm, which is rarely fully resting or uncomfortable. The small size and low profile height) relative to width of the invention has advantages over the prior art. The small size which contacts only with the elbow pressure area allows the pad to fit on most vehicles without custom sizing or trimming to fit around door handles or other door controls. Most car doors have only a small armrest area and the door handle opening is found much further forward of the armrest, which would make the Coates patent unworkable. Many car doors have contoured and sloping armrests that are molded right into the door panel, rather than as a perpendicular shelf. The Tucker patent requires an armrest that can adequately support it from below while Velcro strips hold it to the door panel.

The new invention, having a low profile and fastening directly to the surface with self-adhesive backing, can twist, bend, and contour itself to match the existing armrest with little resistance. The low profile also makes it much less prone to being accidentally knocked off from a side blow or from the door slamming. While it is designed to work on small sloping or contoured molded plastic or rubber armrests, it also works well on most “traditional” flat and perpendicular armrests. A special, tough adhesive liner on the back of the soft, resilient pad allows for removal of the pad without it tearing or leaving any pad particles behind. A plush or slippery, non-irritating coating or surface material, on the top surface of the pad prevents it from rubbing and irritating the elbow. The resilient pad can be made of a foam rubber, a padded fleece, leather, or cloth, or a gas, liquid or gel-filled bladder or other construction, without effecting the claims that follow.

### DETAILED DESCRIPTION OF THE INVENTION:

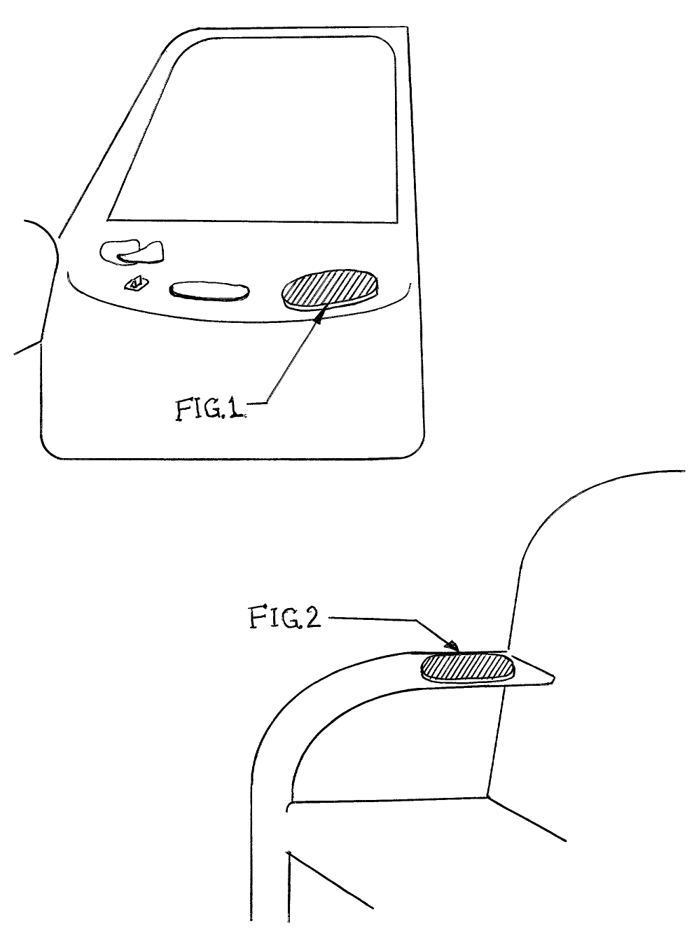

The invention consists of a resilient pad with a flat or contoured upper surface with adhesive backing on the lower surface that can be attached to an existing hard surface such a a vehicle door armrest (FIG.1), or the center console armrest, or to an an armchair with a hard armrest (FIG.2), or to any surface that needs supplemental cushioning material for added elbow comfort.

The “preferred embodiment” is that of an oblong (rounded rectangle), oval, or droplet shaped pad made from foam rubber, foam rubber backed cloth or hide, or from a gel-filled bladder. The preferred dimensions are approx. 2″ to 3″ wide, by approx. 5″ to 6″ long, by approx. ¼″ to ¾″ thick so that it can be located in that area of the existing armrest where the elbow contacts and where the highest levels of skin pressure and friction occur. The preferred self-adhesive backing would be of a thin polymer film substrate with a non-hardening, non-transferring adhesive (such as acrylic based glue) that would allow for the pad to be repositioned or removed without any damage or glue residue or pad material remaining on the original armrest surface. The top surface of the pad would be of a plush or slippery, and non-irritating coating or other surface material such as fine cloth, leather, or fur, to prevent rubbing and chafing of the elbow.

The invention differs from previous embodiments in that it has a relatively smaller size and lower profile to allow it to fit on most modem vehicle or chair armrests that would not permit fitting of the previous patented designs, or that may not permit secure attachment of the previous patents which require either a door handle in the armrest for straps or a large shelf-like armrest perpendicular to the door panel to provide support from below. The low profile ratio (thickness to surface area) of this invention permits it to twist, bend, and contour to most molded door panel armrests and permits it to stay on the often downward sloping armrests that are molded into the curvature of the door panel. The relatively small size allows it to avoid interfering with most door handles and controls without any trimming.

I claim:

1.) A supplemental armrest pad for vehicles and armchairs small enough to relieve the discomfort of pressure and friction only at the elbow contact area, so that most obstacles such as door handles and controls are not in the way of mounting and so that pad trimming is normally not necessary.

2.) A supplemental armrest pad with a low profile ratio (thickness to surface area) permitting it to twist, bend, and contour with a low mechanical resistance to follow the contour of an existing armrest, and allowing it to be securely attached using a non-transferring adhesive backing, and also to resist dislodging by door slam impacts or other lateral forces.

3.) A supplemental armrest pad with a tough “peel and stick” adhesive backing film or liner material that permits the removal of the pad without leaving remnants of the pad or of the adhesive on the surface.
